(19) United States
(12) Patent Application Publication
(10) Pub. No.: US 2019/0321774 A1
(43) Pub. Date: Oct. 24, 2019

(54) METHOD FOR DEPLETING AROMATIC HYDROCARBON FROM A CRUDE GAS FLOW

(71) Applicant: BASF SE, Ludwigshafen am Rhein (DE)

(72) Inventors: Boris BREITSCHEIDEL, Ludwigshafen am Rhein (DE); Tim WELLHAUSEN, Ludwigshafen am Rhein (DE); Friedemann GAITZSCH, Ludwigshafen am Rhein (DE); Peter SCHUNCK, Ludwigshafen am Rhein (DE); Olaf KRIHA, Ludwigshafen am Rhein (DE); Stefan STAUB, Ludwigshafen am Rhein (DE)

(21) Appl. No.: 16/349,725

(22) PCT Filed: Nov. 13, 2017
(86) PCT No.: PCT/EP2017/078979

§ 371 Date: May 14, 2019

(30) Foreign Application Priority Data
Nov. 15, 2016 (EP) 16198907.4

(51) Int. Cl. B01D 53/14; B01D 11/04; B01D 53/18

(52) U.S. Cl. CPC B01D 53/1487; B01D 11/0492; B01D 53/1493; B01D 2252/205; B01D 53/1425; B01D 2256/24; B01D 2257/7027; B01D 53/18

(57) ABSTRACT

A method for depleting aromatic hydrocarbon from a crude gas stream, comprising the use of an absorption medium comprising one or more compounds of the general formula (I):

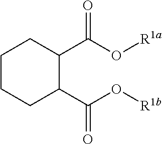

wherein R^{1a} and R^{1b} are each independently C₇ to C₁₂-alkyl and/or one or more compounds of the general formula (II):

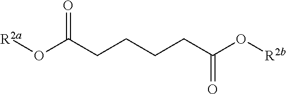

wherein R^{2a} and R^{2b} are each independently C₇ to C₁₂-alkyl.

The removal and/or recovery of aromatic hydrocarbon from gas streams is usually of general interest in the chemical industry owing to the toxicity of these compounds. Gas streams laden with aromatic hydrocarbon may arise, for example, during start-up and shutdown of plants, emptying or venting reaction vessels, pipelines or storage tanks or in other industrial processes, such as in coking plants. The aromatic hydrocarbon can be, for example, benzene, toluene, xy-lenes or any mixture thereof. Due to the low water solubility of aromatic hydrocarbons, which is usually below 2 g/l at 20° C. per compound present, removal from the laden gas streams is generally effected by absorption of the aromatic hydrocarbon in a suitable absorption medium.

In the case of absorption, a compound present in the gas phase is generally absorbed in an absorption medium. The compound present in the gas phase, also referred to as the absorptive, is absorbed in the absorption medium, also referred to as the absorbent. As a result, there is depletion of the compound from the gas phase. In the ideal case, the compound present in the gas phase can be depleted from the gas phase to the extent that the concentration of the compound in the gas phase is below its detection limit. However, it is usually sufficient that the concentration of the compound in the gas phase is within the emission limits specified in the Technical Instruction on Air Quality Control (T A Luft [German Clean Air Regulations] 2002).

The absorption medium is a liquid. The compound absorbed in the absorption medium does not generally undergo any chemical reaction with said absorption medium, but only dissolves therein.

The compound absorbed in the absorption medium can be recovered from the absorption medium by desorption, for example by stripping. In the case of stripping, the absorption medium laden with the absorbed compound is brought into contact with a gas stream, whereby the compound absorbed in the absorption medium passes again into the gas phase. Suitable gases that can be used for stripping are, for example, steam, nitrogen, air, carbon dioxide or any mixture thereof. Advantageously in this case, the temperature may additionally be increased and/or the ambient pressure decreased. In the ideal case, the compound absorbed in the absorption medium can be removed therefrom to the extent that the concentration of the compound in the absorption medium is below its detection limit. The laden absorption medium can be regenerated by desorption and used repeatedly as absorption medium. Thus, the possibility arises of a recirculation process.

By means of absorption in an absorption medium, mixtures of two or more compounds different from one another can also be depleted, for example be removed, from the gas phase. By means of desorption, the compounds present in a laden absorption medium can be removed again from said absorption medium. In the ideal case, all compounds present in the mixture are removed from the absorption medium until below the respective detection limit.

Various methods for absorption of gas streams are known from the prior art or are accessible to those skilled in the art from their general technical knowledge (for example from VDI (German Engineering Association) guidelines, wet precipitator: Offgas purification by absorption (scrubbers), VDI 3679, Sheet 2, July 2014).

For instance, WO2009/003644 discloses according to the description a method for depleting aromatic hydrocarbon from coke oven gas using biodiesel as absorption medium.

The present disclosure has the object of providing a method with which aromatic hydrocarbon, especially benzene, can be depleted from a crude gas stream. The absorption medium used should also be easy to handle and able to be regenerated. Furthermore, a low vapor pressure of the absorption medium can be advantageous in order to keep solvent losses low.

In the present context a method is disclosed for depleting aromatic hydrocarbon from a crude gas stream, comprising the use of an absorption medium comprising one or more compounds of the general formula (I):

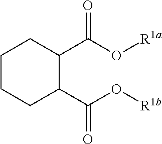

wherein R^{1a} and R^{1b} are each independently C₇ to C₁₂-alkyl and/or one or more compounds of the general formula (II):

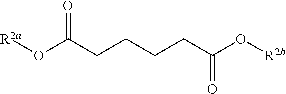

wherein R^{2a} and R^{2b} are each independently C₇ to C₁₂-alkyl.

An absorption medium is disclosed comprising one or more compounds of the general formula (I) and/or formula (II).

Also disclosed is the use of one or more compounds of the general formula (I) and/or of one or more compounds of the general formula (II) as a constituent of an absorption medium.

The disclosure further relates to a device specifically for depleting aromatic hydrocarbon from a crude gas stream, in which the absorption medium disclosed is brought into contact with the crude gas stream in co-current or countercurrent flow.

### DESCRIPTION OF THE INVENTION

The depletion of aromatic hydrocarbon from a crude gas stream generally takes place by absorption of the aromatic hydrocarbon in an absorption medium. By absorption of the aromatic hydrocarbon in the absorption medium, this passes into the absorption medium. The transfer of the aromatic hydrocarbon into the absorption medium can also be considered as a dissolution of the aromatic hydrocarbon in the absorption medium. In general, there is no chemical reaction of the aromatic hydrocarbon present in the crude gas stream and of the aromatic hydrocarbon dissolved in the absorption medium with the absorption medium.

In general, the aromatic hydrocarbon is present in gaseous form in the crude gas stream. However, it can also be the case that the aromatic hydrocarbon is present in the crude gas stream as finely divided liquid. For instance, the aromatic hydrocarbon may be present in the crude gas stream as a mist or aerosol. Evidently, it may also be that some of the aromatic hydrocarbon in the crude gas stream is present as a gas and some of the aromatic hydrocarbon as a liquid. In which form the aromatic hydrocarbon is present in the crude gas stream can be dependent, for example, on the aromatic hydrocarbon itself, the concentration of the aromatic hydrocarbon in the crude gas stream, the temperature and/or the ambient pressure.

The absorption of the aromatic hydrocarbon in the absorption medium generally depends on various parameters such as the temperature of the crude gas stream, the temperature of the absorption medium and/or the ambient pressure. The aromatic hydrocarbon is partially or completely depleted from the crude gas stream by absorption in the absorption medium. The aromatic hydrocarbon can be one aromatic hydrocarbon or any mixture of different aromatic hydrocarbons. Since the aromatic hydrocarbon can be any mixture of different aromatic hydrocarbons, it may be that one or more aromatic hydrocarbons of the mixture are better depleted than others from the crude gas stream by absorption in the absorption medium. If one or more aromatic hydrocarbons are completely depleted from the crude gas stream, their concentration in the crude gas stream is generally below the respective detection limit or respective detection limits.

An aromatic hydrocarbon may have one or more aromatic rings. If an aromatic hydrocarbon has more than one aromatic ring, the aromatic rings may be fused, linked by alkyl bridges, by a di-rect bond and/or by heteroatoms.

An aromatic hydrocarbon generally consists of carbon and hydrogen. However, an aromatic hydrocarbon may also comprise one or more heteroatoms in the aromatic ring. A heteroatom may be, for example, nitrogen, oxygen or sulfur.

An aromatic hydrocarbon may comprise one or more substituents on the aromatic ring. In the case of two or more substituents, the substituents may be identical or different from one another. In the case of an aromatic hydrocarbon having more than one aromatic ring, each ring may each independently comprise one or more substituents.

A substitute on the aromatic ring may be, for example, C₁- to C₆-alkyl. C₁- to C₆-alkyl can be straight-chain or branched. For example, C₁- to C₆-alkyl can be methyl, ethyl, propyl, isopropyl, n-butyl, isobutyl, n-pentyl, 2-pentyl, 3-pentyl, 2-methylbutyl, 3-methylbutyl, 3-methylbut-2-yl, 2-methylbut-2-yl, 2,2-dimethylpropyl, n-hexyl, 2-methylpentyl, 3-methylpentyl, 2,3-dimethylbutyl or 2,2-dimethylbutyl. C₁- to C₆-alkyl may also form a fused ring with the aromatic ring.

A substituent on the aromatic ring can also be, for example, C₂- to C₆-alkyl having at least one double bond in the alkyl chain. C₂- to C₆-alkyl having at least one double bond in the alkyl chain can be straight-chain or branched. For example, C₂- to C₆-alkyl having at least one double bond in the alkyl chain can be vinyl or allyl. C₃- to C₆-alkyl having at least one double bond in the alkyl chain may also form a fused ring with the aromatic ring.

A substituent on the aromatic ring may be, for example, C₁- to C₄-alkyl having at least one heteroatom in the alkyl chain. The heteroatom can in this case be bonded directly to the aromatic ring. For example, C₁- to C₆-alkyl having at least one heteroatom in the alkyl chain can be meth-oxy, ethoxy, propoxy, isopropoxy, n-butoxy, isobutoxy, tert-butoxy, dimethylamino, methylthio or ethylthio. C₂- to C₆-alkyl having at least one heteroatom in the alkyl chain may also form a fused ring with the aromatic ring.

A substituent on the aromatic ring may also be a heteroatom for example, free valencies of which are saturated with hydrogen atoms. Heteroatom substituents of which free valencies are saturated with hydrogen atoms may be, for example, —NH₂, —OH or —SH.

Aromatic hydrocarbon may be, for example, pyridine, quinoline, indol, thiophene, benzene, toluene, o-xylene, m-xylene, p-xylene, ethylbenzene, styrene, indane, indene, naphthalene or any mixture thereof. The aromatic hydrocarbon is usually benzene, toluene, o-xylene, m-xylene, p-xylene, ethylbenzene, styrene, indane, indene, or any mixture thereof. The aromatic hydrocarbon is especially benzene and/or toluene.

A crude gas stream generally comprises aromatic hydrocarbon and a carrier gas. A carrier gas can be air, nitrogen, oxygen, argon, helium, carbon dioxide or any mixture thereof. The carrier gas is usually air, steam, nitrogen or any mixture therefore.

A crude gas stream may comprise, for example, benzene, toluene, o-xylene, m-xylene, p-xylene, ethylbenzene, styrene, indane, indene or any mixture thereof and air and/or nitrogen. A crude gas stream usually comprises benzene and/or toluene and air and/or nitrogen.

A crude gas stream may be, for example, an offgas stream or process gas stream. An offgas stream may arise, for example, in the case of venting a storage tank for aromatic hydrocarbons or venting a reactor or pipeline which have come into contact with aromatic hydrocarbons. Generally, an offgas stream is not used in any further process step. A process gas stream can arise, for example during start-up and shutdown of plants which have come into contact with aromatic hydrocarbons, or in coking plants, such as in coking of coal. It may be that a process gas stream is further used in a further directly or indirectly following process step.

In general, the method disclosed for depleting aromatic hydrocarbon from a crude gas stream is used wherein the crude gas stream comprises 10 to 100 000 mg/Nm³ of aromatic hydrocarbon. Preferably, the crude gas stream comprises 20 to 80 000 mg/Nm³ of aromatic hydrocarbon and more preferably 30 to 60 000 mg/Nm³ of aromatic hydrocarbon.

In general, the absorption medium comprises one or more compounds of the general formula (I) and/or one or more compounds of the general formula (II). Specifically, the absorption medium disclosed is an absorption medium for hydrocarbon and more specifically for aromatic hydrocarbon.

In a compound of the general formula (I), R^{1a} and R^{1b} are each independently C₇- to C₁₂-alkyl. C₇- to C₁₂-alkyl can be straight-chain or branched. For example, C₇- to C₁₂-alkyl can be n-heptyl, 1-methylhexyl, 2-methylhexyl, 1-ethylpentyl, 2-ethylpentyl, 1-propylbutyl, 1-ethyl-2-methylpropyl, n-octyl, isooctyl, 2-ethylhexyl, n-nonyl, isononyl. It may be preferable that R²a and R²b are each independently C₈- to C₉-alkyl. C₈- to C₉-alkyl can be straight-chain or branched. For example, C₈- to C₉-alkyl can be n-octyl, isooctyl, 2-ethylhexyl, n-nonyl, isononyl.

In a compound of the general formula (II), R²a and R²b are each independently C₇- to C₁₂-alkyl. C₇- to C₁₂-alkyl can be straight-chain or branched. For example, C₇- to C₁₂-alkyl can be n-heptyl, 1-methylhexyl, 2-methylhexyl, 1-ethylpentyl, 2-ethylpentyl, 1-propylbutyl, 1-ethyl-2-methylpropyl, n-octyl, isooctyl, 2-ethylhexyl, n-nonyl, isononyl. It may be preferable that R^{2a} and R^{2b} are each independently C₈- to C₉-alkyl. C₈- to C₉-alkyl can be straight-chain or branched. For example, C₈- to C₉-alkyl can be n-octyl, isooctyl, 2-ethylhexyl, n-nonyl, isononyl.

The absorption medium disclosed generally comprises largely one or more compounds of the general formula (I) and/or formula (II). The content of one or more compounds of the general formula (I) and/or formula (II) in the absorption medium disclosed is generally at least 80 percent by weight, based on the total mass of the absorption medium. It may be preferable that the content of one or more compounds of the general formula (I) and/or formula (II) is at least 85 percent by weight and further at least 95 percent by weight.

The absorption medium may also comprise additives. Additives can be selected, for example, such that the absorption properties and/or stability and/or application properties of the absorption medium can be positively influenced. For instance, the absorption medium may comprise additives for example which lower the viscosity. Additives which positively influence the application properties can be, for example, antifreezes or defoamers. The absorption medium may also comprise one or more additives. In selecting the additives, a person skilled in the art focuses on the application-specific requirements in each case.

The absorption medium can also comprise one or more compounds that are suitable for absorption of hydrocarbon and especially aromatic hydrocarbon and which are different from the compounds of the general formula (I) or (II). A compound of this kind may be, for example, a compound of the general formula (III), a silicone oil, a paraffin, a high-boiling ester which is not a compound of the general formula (I), (II) or (III), or an ethylene glycol dialkyl ether or any mixtures thereof.

A compound of the general formula (III) is:

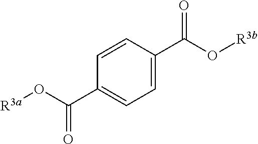

In a compound of the general formula (III), R^{1a} and R^{1b} are each independently C₇- to C₁₂-alkyl. C₇ to C₁₂-alkyl can be straight-chain or branched. For example, C₇ to C₁₂-alkyl can be n-heptyl, 1-methylhexyl, 2-methylhexyl, 1-ethylpentyl, 2-ethylpentyl, 1-propylbutyl, 1-ethyl-2-methylpropyl, n-octyl, isooctyl, 2-ethylhexyl, n-nonyl, isononyl. A compound of the general formula (III) can be, for example, di(2-ethylhexyl) terephthalate.

Further compounds are known to those skilled in the art or are accessible by means of practical considerations or from general technical knowledge (Schultes, Offgas purification & Geisthardt, K. Chem. Eng. Technol. 12(1989) 63 to 70, VDI Guidelines, wet separator: Offgas purification by absorption (scrubbers), VDI 3679, Sheet 2, July 2014).

It may be preferable that the absorption medium comprises one or more compounds of the general formula (I) or one or more compounds of the general formula (II). It may be further preferable that the absorption medium comprises a compound of the general formula (I) and Ria and Rib are identical or comprises a compound of the general formula (II) and R²a and R²b are identical. It may be particularly preferable that the absorption medium comprises di(isononyl) 1,2-cyclohexanedicarboxylate or di(2-ethylhexyl) adipate.

For instance, it may be preferable that the absorption medium comprises at least 80 percent by weight, based on the total mass of the absorption medium, of a compound of the general formula (I) or general formula (II). It may be further preferable that the absorption medium comprises at least 80 percent by weight of a compound of the general formula (I) in which R^{1a} and R^{1b} are identical or of a compound of the general formula (II) in which R²a and R²b are identical. It may be particularly preferable that the absorption medium comprises at least 80 percent by weight of di(isononyl) 1,2-cyclohexanedicarboxylate or 80 percent by weight of di(2-ethylhexyl) adipate.

A method for depleting aromatic hydrocarbon from a crude gas stream can therefore include:

the use of an absorption medium comprising one or more compounds of the general formula (I) and/or formula (II),
or,
the use of an absorption medium comprising one or more compounds of the general formula (I) and/or one or more compounds of the general formula (II), wherein the aromatic hydrocarbon comprises benzene and/or toluene
or,
the use of an absorption medium comprising a compound of the general formula (I) and R^{1a} and R^{1b} are identical, or comprising a compound of the general formula (II) and R^{2a} and R^{2b} are identical
or,
the use of an absorption medium comprising a compound of the general formula (I) and R^{1a} and R^{1b} are identical, or comprising a compound of the general formula (II) and R^{2a} and R^{2b} are identical, wherein the content of the compound of the general formula (I) or formula (II) in the absorption medium is at least 80 percent by weight
or,
the use of an absorption medium comprising di(isononyl) 1,2-cyclohexanedicarboxylate
or,
the use of an absorption medium comprising di(isononyl) 1,2-cyclohexanedicarboxylate, wherein the content of di(isononyl) 1,2-cyclohexanedicarboxylate in the absorption medium is at least 80 percent by weight
or,
the use of an absorption medium comprising di(isononyl) 1,2-cyclohexanedicarboxylate, wherein the content of di(isononyl) 1,2-cyclohexanedicarboxylate in the absorption medium is at least 80 percent by weight, and wherein the aromatic hydrocarbon is benzene and/or toluene
or,
the use of an absorption medium comprising di(2-ethylhexyl) adipate
or,
the use of an absorption medium comprising di(2-ethylhexyl) adipate, wherein the content of di(2-ethylhexyl) adipate in the absorption medium is at least 80 percent by weight.

The method disclosed for depleting aromatic hydrocarbon from a crude gas stream can also be combined in combination with other methods which serve to purify gas. The method disclosed can be such a method upstream and/or downstream. For instance, the method disclosed can be combined, for example, with a filtration method and/or a condensation method and/or a mem-brane method. The method disclosed can also be combined, for example, with other methods which are known to to those skilled in the art or are revealed to them from their general technical knowledge.

One or more compounds of the general formula (I) and/or formula (II) can accordingly be used as constituents of an absorption medium. Specifically, one or more compounds of the general formula (I) and/or formula (II) can be used as constituents of an absorption medium for hydrocarbon and further for aromatic hydrocarbon. It may be preferable that a compound of the general formula (I) in which R^{1a} and Rib are identical, or a compound of the general formula (II) in which R^{2a} and R^{2b} are identical, is used as constituent of an absorption medium. It may be further preferable that di(isononyl) 1,2-cyclohexanedicarboxylate or di(2-ethylhexyl) adipate is used as constituent of an absorption medium.

The depletion of aromatic hydrocarbon from the crude gas stream using the disclosed absorption medium can take place in a scrubber. It is also possible to connect several scrubbers, for example two or more scrubbers, in series and/or in parallel. Several scrubbers can also be connected in series, wherein the absorption medium in one or more scrubbers is different from the absorption medium disclosed, but the absorption medium disclosed is in at least one scrubber.

The sequence of the scrubbers connected in series with different absorption medium can be as desired. The arrangement of the scrubbers can be guided by those skilled in the art from practical and process-specific considerations and/or from general technical knowledge.

For instance, in a first scrubber the absorption medium can be the absorption medium disclosed and in a second scrubber, connected in series, the absorption medium can be different to the absorption medium disclosed. An absorption medium different to the absorption medium disclosed is free of compounds of the general formula (I) and/or formula (II).

An absorption medium different to the absorption medium disclosed can be polar or non-polar. An absorption medium different to the absorption medium disclosed may serve, for example, to further deplete organic compounds and especially aromatic hydrocarbon from the crude gas stream. The organic compounds, in addition to aromatic hydrocarbon, may also be non-aromatic hydrocarbon, ketones, alcohols, esters, ethers or any desired mixture thereof. An absorption medium different to the absorption medium disclosed can comprise, for example, one or more compounds of the general formula (III), one or more silicone oils, one or more paraffins, one or more high-boiling esters, wherein the high-boiling esters are not compounds of the general formula (I), (II) or (III), one or more ethylene glycol dialkyl ethers, one or more pyrrolidones or any mixture thereof.

In the selection of a suitable absorption medium which is different from the absorption medium disclosed, those skilled in the art can be guided by practical and process-specific considerations and/or by their general technical knowledge (VDI Guidelines, wet separator: Offgas purification by absorption (scrubbers), Vol 3679, Sheet 2, July 2014).

The present invention for depleting aromatic hydrocarbon comprising the use of an absorption medium comprising one or more compounds of the general formula (I) and/or of the general formula (II) may accordingly also include the use of a further absorption medium, in which this is different to the absorption medium disclosed. It may be preferable in this case that the absorption medium different to the absorption medium disclosed is used for depleting inorganic compounds from the crude gas stream. An absorption medium of this kind may be, for example, water, methanol, ethanol or any desired mixture thereof. Preference is generally given to water. In this case, water can be used for example as demineralized water or process water. It may also be preferable that the absorption medium disclosed comprises di(isononyl) 1,2-cyclohexanedicarboxylate and that the absorption medium different to the absorption medium disclosed is used for depleting inorganic compounds from the crude gas stream. It may be further preferable that the absorption medium disclosed comprises di(isononyl) 1,2-cyclohexanedicarboxylate and that the absorption medium different to the absorption medium disclosed is used for depleting inorganic compounds from the crude gas stream and comprises water.

The absorption medium different to the absorption medium disclosed is generally used in a further process operation. A further process operation can be an upstream and/or downstream process operation. The inorganic compounds can therefore be depleted from the crude gas stream in a further process operation using an absorption medium different to the absorption medium disclosed.

In order to bring the crude gas stream and the absorption medium disclosed into contact, these are fed past each other in co-current or countercurrent flow. A countercurrent flow feeding is considered to be advantageous in this case. The crude gas stream and the absorption medium disclosed can be brought into contact in all devices known to those skilled in the art which are suitable for such a purpose. Such devices in general and in the context of this disclosure are referred to as scrubbers.

In order to improve contact between the absorption medium and crude gas stream it is generally of advantage that the absorption medium has a large surface area. A large surface area can be achieved, for example, by atomization, dropletization or by film formation of the absorption medium. For this purpose, a scrubber may comprise, for example, one or more co-current or countercurrent columns with random packings, plates or with structured packings, one or more spray apparatuses, one or more bubble columns, or any desired combination.

A scrubber can be a mobile device or a fixedly installed device. If the scrubber is a mobile device, the site of use of the scrubber can be varied. For example, the scrubber can be installed on a vehicle.

The disclosure accordingly further also can be a method for depleting aromatic hydrocarbon from a crude gas stream, comprising the use of an absorption medium comprising one or more compounds of the general formula (I) and/or formula (II), wherein the absorption medium and the crude gas stream are fed past each other in co-current or countercurrent flow or,

a method for depleting aromatic hydrocarbon from a crude gas stream, comprising the use of an absorption medium comprising di(isononyl) 1,2-cyclohexanedicarboxylate, wherein the absorption medium and the crude gas stream are fed past each other in co-current or countercurrent flow or,
a method for depleting aromatic hydrocarbon from a crude gas stream, comprising the use of an absorption medium comprising di(isononyl) 1,2-cyclohexanedicarboxylate and a further absorption medium, which is different from the absorption medium above, water for example, wherein the absorption medium and the crude gas stream are fed past each other in co-current or countercurrent flow.

The disclosure also relates to a device specifically for depleting aromatic hydrocarbon from a crude gas stream, in which the absorption medium disclosed is brought into contact with a crude gas stream in co-current or countercurrent flow. The device disclosed can be a scrubber for example. It can also be the case, however, that one or more scrubbers are present in the device. One or more scrubbers and and or more regenerating devices can also be present in the device disclosed.

The depletion of aromatic hydrocarbon from the crude gas stream using the absorption medium disclosed may be dependent on the temperature of the crude gas stream and/or the temperature of the absorption medium.

When depleting aromatic hydrocarbon from the crude gas stream using the disclosed absorption medium, the crude gas stream is generally at ambient temperature. The crude gas stream can however also be heated above ambient temperature or cooled below ambient temperature.

For instance, the crude gas stream may have a temperature from −20 to 200° C. The crude gas stream usually has a temperature of 0 to 60° C. The crude gas stream can also have a temperature from 10 to 40° C.

The absorption medium is generally at ambient temperature. The absorption medium can however also be heated above ambient temperature or cooled below ambient temperature. For instance, the absorption medium may have a temperature from −20 to 200° C. The absorption medium usually has a temperature of 0 to 60° C. The absorption medium can also have a temperature from 10 to 40° C.

The crude gas stream and absorption medium can have the same or different temperatures. It may be preferable that the temperature of the crude gas stream is above the temperature of the absorption medium. However, the temperature of the crude gas stream and absorption medium cannot be substantially different. For instance, the temperature of the crude gas stream and absorption medium can be different, for example, by 20° C. or less.

The depletion of aromatic hydrocarbon from the crude gas stream using the disclosed absorption medium may be dependent on the ambient pressure. For instance, the depletion of aromatic hydrocarbon from the crude gas stream using the disclosed absorption medium can take place, for example, at elevated pressure. Generally, the aromatic hydrocarbon is depleted from the crude gas stream using the disclosed absorption medium at standard pressure or slightly elevated pressure. Slightly elevated pressure can then be present if the pressure is above standard pressure. For instance, the pressure can be up to 80 mbar above standard pressure. It may be preferable that the pressure is up to 50 mbar above ambient pressure. It may be further preferable that the pressure is up to 20 mbar above ambient pressure.

When adjusting the temperature of the crude gas stream and/or absorption medium and/or ambient pressure, a person skilled in the art is guided by practical considerations and general technical knowledge in order to select advantageous values for the process regime and to ensure the most efficient depletion of the aromatic hydrocarbon from the crude gas stream.

After absorption of the aromatic hydrocarbon in the absorption medium disclosed, the absorption medium is laden with aromatic hydrocarbon. The absorption medium laden with aromatic hydrocarbon can be discarded or regenerated.

It the absorption medium laden with aromatic hydrocarbon is discarded it can, for example, be fed to a flare and be combusted. The absorption medium laden with aromatic hydrocarbon can also be used thermally for energy generation. In this case, it may be advantageous that other fossil and/or bio-based energy carriers are mixed with the absorption medium laden with aromatic hydrocarbon before this is used thermally.

The absorption medium laden with aromatic hydrocarbon can also be regenerated. By means of regeneration, aromatic hydrocarbon and/or the absorption medium with a low loading of aromatic hydrocarbon or free from aromatic hydrocarbon can be recovered. This can have the advantage that the absorption medium obtained after regeneration can be used repeatedly for depleting aromatic hydrocarbon from a crude gas stream. The regeneration is generally carried out in a regeneration device suitable for this purpose.

A regeneration device can be a mobile device or a fixedly installed device. If the regeneration device is a mobile device, the site of use of the regeneration device can be varied. For example, the regeneration device can be installed on a vehicle.

For instance, in a method for depleting aromatic hydrocarbon from a crude gas stream, comprising an absorption medium comprising one or more compounds of the general formula (I) or formula (II), the absorption medium can be regenerated. Also, in a method for depleting aromatic hydrocarbon from a crude gas stream, comprising an absorption medium comprising di(isononyl) 1,2-cyclohexanedicarboxylate, the absorption medium can be regenerated.

The absorption medium laden with aromatic hydrocarbon can be regenerated, for example, by desorption of the aromatic hydrocarbon. Desorption of the aromatic hydrocarbon can be effected, for example, by stripping and/or temperature increase and/or pressure decrease. To de-sorb the aromatic hydrocarbon from the laden absorption medium by stripping, the absorption medium laden with aromatic hydrocarbon can be brought into contact with a stripping medium in a regeneration device. The aromatic hydrocarbon absorbed in the absorption medium is in this case partially or completely removed from the absorption medium and transfers into the stripping medium. The aromatic hydrocarbon then present in the stripping medium can then for example be condensed out and thus be recovered.

A stripping medium may be non-condensable gases such as air, nitrogen or steam, carbon dioxide or any mixture thereof. Generally, the stripping medium is steam. The absorption medium laden with aromatic hydrocarbon is accordingly regenerated, for example, by means of stripping with steam.

In order to bring the stripping medium into contact with the absorption medium laden with aromatic hydrocarbon, stripping medium and laden absorption medium are generally passed by each other in co-current or countercurrent flow. This takes place in a regeneration device. In order to improve contact between stripping medium and absorption medium, it can be advantageous that the absorption medium has a large surface area. A large surface area can be achieved, for example, by atomization, dropletization or by film formation of the absorption medium. For this purpose, for example, it is possible to use one or more co-current or countercurrent columns with random packings, plates or with structured packings, one or more spray apparatuses, one or more bubble columns, or any desired combination thereof. A regeneration device may accordingly comprise one or more co-current or countercurrent columns with random packings, plates or with structured packings, one or more spray apparatuses, one or more bubble columns, or any desired combination thereof.

The regeneration of the absorption medium laden with aromatic hydrocarbon may be dependent on the temperature of the laden absorption medium, the temperature of the stripping medium, the ratio of laden absorption medium and stripping medium and/or the ambient pressure/system pressure.

During the regeneration of the absorption medium laden with aromatic hydrocarbon, the laden absorption medium generally has a temperature from 20 to 100° C. The laden absorption medium can be heated or cooled for this purpose. It may be preferable that the laden absorption medium has a temperature from 25 to 80 and more preferably a temperature from 30 to 70° C. The stripping medium generally has a temperature from 20 to 200° C. The stripping medium can be heated or cooled for this purpose. It may be preferable that the stripping medium has a temperature from 25 to 150° C. and more preferably a temperature from 30 to 145° C.

The laden absorption medium can be heated by methods known per se to a person skilled in the art, for example by means of a heat exchanger. It may be further preferable when heating the laden absorption medium that absorption and regeneration are heated in an integrated system.

The laden absorption medium and the stripping medium can have the same or different temperatures.

The regeneration of the absorption medium laden with aromatic hydrocarbon generally takes place at ambient pressure. However, it may also be preferable that the absorption medium laden with aromatic hydrocarbon is regenerated at reduced pressure. Reduced pressure can signify that the pressure at which the regeneration takes place is below ambient pressure. For instance, the absorption medium laden with aromatic hydrocarbon can be regenerated, for example, at a pressure from 20 mbar to standard pressure. Preferably, the regeneration is effected at a pressure from 50 mbar to standard pressure and more preferably at a pressure from 100 mbar to standard pressure. For instance, the regeneration can be carried out for example at a pressure which is 80 mbar, 50 mbar or 20 mbar below standard pressure.

By combining a scrubber and a regeneration device, aromatic hydrocarbon can be depleted continuously from a crude gas stream for example. The depletion of aromatic hydrocarbon from a crude gas stream using the disclosed absorption medium can also be effected discontinu-ously.

The absorption medium disclosed is advantageously only poorly soluble in water, whereby said absorption medium can be simply regenerated by stripping with steam. In order for the stripping to be suitable, it is also of advantage if the absorption medium disclosed is stable under the stripping conditions. The absorption medium disclosed is also advantageously not readily vola-tile at ambient temperature. An indication of high volatility can be a high vapor pressure. Therefore, the vapor pressure of the absorption medium disclosed is advantageously low. A low vapor pressure can be, for example, less than 0.05 Pa at 25° C. It may be preferable that a low vapor pressure is less than 0.005 Pa at 25° C. It is a further advantage if the absorption medium disclosed can be easily obtained and used. If, for example, biodiesel is used as absorption medium, this is subject to specific requirements and regulations since it is an energy-intensive substance which is used in other applications also for generating energy.

Preparation of Compounds of the General Formula (I)

The compounds of the general formula (I) can either be purchased commercially or can be prepared by methods which are either known to those skilled in the art or are accessible to them by their general technical knowledge.

As a rule, 1,2-cyclohexanedicarboxylates are usually obtained by ring hydrogenation of the corresponding phthalic esters. The ring hydrogenation can be effected, for example, by processes described in WO 99/32427. WO 2011/082991 A2 for example also describes a particularly suitable ring hydrogenation method.

In addition, 1,2-cyclohexanedicarboxylates can be obtained, for example by esterification of 1,2-cyclohexanedicarboxylic acid or suitable derivatives thereof with the corresponding alcohols. Methods and specific process steps are either known to those skilled in the art or are accessible to them by their general technical knowledge (see for example WO 2015/082676, suitable esterification and transesterification methods can be taken by analogy from WO 2016/005357). Common to methods for preparing the compounds of the general formula (I) is that, starting from phthalic acid, 1,2-cyclohexanedicarboxylic acid or suitable derivatives thereof, an esterification or transesterification is carried out in which the corresponding C₇-C₁₂-alkanols are used as reactants. These alcohols are generally not pure substances but are isomeric mixtures, the composition and degree of purity of which depends on the respective methods with which these have been prepared.

C₇-C₁₂-alkanols, which are used for preparing the compounds of the general formula (I), can be straight-chain or branched or consist of mixtures of straight-chain and branched C₇-C₁₂-alkanols. These include for example n-heptanol, isoheptanol, n-octanol, isooctanol, 2-ethylhexanol, n-nonanol, isononanol, isodecanol, 2-propylheptanol, n-undecanol, isoundecanol, n-dodecanol or isododecanol. It may be preferable that 2-ethylhexanol, isononanol and 2-propylheptanol are used as alkanols and that isononanol is further used.

Preparation of Compounds of the General Formula (II)

The compounds of the general formula (II) can either be purchased commercially or can be prepared by methods which are either known to those skilled in the art or are accessible to them by their general technical knowledge.

In general, the compounds of the general formula (II) are obtained by esterification of adipic acid, or suitable derivatives thereof, with the appropriate alcohols. Methods and specific process steps are either known to those skilled in the art or are accessible to them by their general technical knowledge. Dialkyl adipates with C₇- to C₁₂-alcohols can be prepared, for example, in analogy to the method disclosed in WO 2016/005357 using C₇- to C₁₂-alcohols in place of C₃- to C₅-alcohols.

Common to methods for preparing the compounds of the general formula (II) is that, starting from adipic acid, or suitable derivatives thereof, an esterification or transesterification is carried out in which the corresponding C₇ to C₁₂-alkanols are used as reactants. These alcohols are generally not pure substances but are isomeric mixtures, the composition and degree of purity of which depends on the respective methods with which these have been prepared.

Preferred C₇ to C₁₂-alkanols, which are used for preparing the compounds of the general formula (II),can be straight-chain or branched or consist of mixtures of straight-chain and branched C₇- to C₁₂-alkanols. These include n-heptanol, isoheptanol, n-octanol, isooctanol, 2-ethylhexanol, n-nonanol, isononanol, isodecanol, 2-propylheptanol, n-undecanol, isoundecanol, n-dodecanol or isododecanol. It may be preferable that C₇ to C₁₀-alkanols such as 2-ethylhexanol, isononanol and 2-propylheptanol are used and that more preferably 2-ethylhexanol is used.

### Preparation of Compounds of the General Formula (III)

The compounds of the general formula (III) can either be purchased commercially or can be prepared by methods which are either known to those skilled in the art or are accessible to them by their general technical knowledge.

In general, the dialkyl terephthalates are obtained by esterification of terephthalic acid, or suitable derivatives thereof, with the appropriate alcohols. Methods and specific process steps are either known to those skilled in the art or are accessible to them by their general technical knowledge (see for example WO 2015/162142, suitable esterification and transesterification methods can be taken by analogy from WO 2016/005357).

Common to methods for preparing the compounds of the general formula (III) is that, starting from terephthalic acid, or suitable derivatives thereof, an esterification or transesterification is carried out in which the corresponding C₇ to C₁₂-alkanols are used as reactants. These alcohols are generally not pure substances but are isomeric mixtures, the composition and degree of purity of which depends on the respective methods with which these have been prepared.

Preferred C₇ to C₁₂-alkanols, which are used for preparing the compounds of the general formula (III),can be straight-chain or branched or consist of mixtures of straight-chain and branched C₇- to C₁₂-alkanols. These include n-heptanol, isoheptanol, n-octanol, isooctanol, 2-ethylhexanol, n-nonanol, isononanol, isodecanol, 2-propylheptanol, n-undecanol, isoundecanol, n-dodecanol or isododecanol. It may be preferable that C₇ to C₁₀-alkanols such as 2-ethylhexanol, isononanol and 2-propylheptanol are used and that more preferably 2-ethylhexanol is used.

Preparation of C₇- to C₁₂-Alcohols for the Synthesis of the Compounds of the General Formula (I, II, or III)

Methods for preparing C₇- to C₁₂-alcohols are generally known to those skilled in the art or are accessible to them by their general technical knowledge. The preparation of C₇- to C₁₂-alcohols is usually associated with the technical field of plasticizers (alcohols). The person skilled in the art would therefore consult the field of plasticizers or draw upon publications in this field relating to the preparation of C₁ to C₁₂-alcohols. The preparation of heptanols is described by way of example in WO2015/082676. Likewise, WO2015/082676 describes the preparation of octanols (such as 2-ethylhexanol), nonanols (such as isononanol), decanols, undecanols or dodecanols.

### EXAMPLES

The examples are intended to elucidate the invention and do not represent any limitation thereto.

Aromatic hydrocarbon is determined by headspace GC:
The headspace conditions are as follows:
Temperature control period: 60 min
Set temperature: 70° C.
Transfer line: 150° C.
Injection: Head-space autosampler, high pressure metering (1.5 to 2 bar)
For sample preparation, 1 ml of dist. water was added to ca. 50 mg of the sample and analyzed.

In all examples, di(isononyl) 1,2-cyclohexanedicarboxylate used was Hexamoll®DINCH®, di(2-ethylhexyl) adipate used was Plastomoll®DOA and di(2-ethylhexyl) terephthalate used was EASTMAN 168™. White oil used was WINOG 70 from H&R KGaA.

Presented in Table 1 are substance properties of Hexamoll® DINCH® (di-(isononyl) 1,2-cyclohexanedicarboxylate), Plastomoll® DOA (di(2-ethylhexyl) adipate), Eastmann 168™ (di(2-ethylhexyl) terephthalate) and Agnique® ME 18 RD-F (biodiesel).

| | | | | Dynamic | Vapor | Boiling point |
|---|---|---|---|---|---|---|
| | | Molecular | Density at | viscosity at | pressure | at standard |
| | CAS | weight g/mol | 20° C. kg/m³ | 20° C. mPa*s | Pa | pressure ° C. |
| Hexamoll ® | 166414-78-8 | 424.7 | 948 | 52 | 0.0001 | 394 |
| DINCH ®* | | | (DIN 51757/D 4052) | (DIN 51562/D445) | (20° C.) | |
| Plastomoll ® | 103-23-1 | 370.6 | 925 | 13.7 | 0.00003 | 417 |
| DOA* | | | DIN 51757) | (ASTM D 7042) | (20° C.) | |
| Eastmann | 6422-86-2 | 390.6 | 980 | 65.8 | 0.001 | 375 |
| 168 ™* | | | (ASTM D-4052) | (OECD 114) | (25° C.) | |
| Agnique ® | 67762-38-3 | | 880 | 6 | 420 | 351 to 360 |
| ME 18 RD-F* | | | (ISO 6883) | (DIN 53015) | (25° C.) | |
| WINOG 70* | no | unknown | 867 | 61 | 10 | unknown |
| | | | (15° C.) | (15° C.) | (20° C.) | |
| | | | (DIN 51757) | (DIN 51562) | | |

*In the case of the compounds used, depending on the source and/or manufacturing process, they can be mixtures of various compounds (often isomeric mixtures). The values stated may therefore vary slightly depending on the composition of the compounds used.

The composition of Agnique® ME 18 RD-F is shown in Table 2.

| | | |
|---|---|---|
| Water fraction | <0.02% | ISO 4317 |
| Acid number | <0.5 mg KOH/g | ISO 660 |
| Iodine number | 100 to 120 g l/100 g | ISO 3961 |
| Density | 0.87 to 0.89 g/cm³ | ISO 6883 |
| Fatty acid methyl esters C14:0 | <0.2% | ISO 5508 |
| Fatty acid methyl esters C16 | 3.5 to 6.0% | ISO 5508 |
| Fatty acid methyl esters C18 | 90 to 95% | ISO 5508 |
| Fatty acid methyl esters C20 | 1.0 to 2.0% | ISO 5508 |
| Fatty acid methyl esters C22 | <0.5% | ISO 5508 |

Owing to the low vapor pressure of Hexamoll® DINCH® (di(isononyl) 1,2-cyclohexanedicarboxylate), Plastomoll® DOA (di(2-ethylhexyl) adipate) and Eastman 168™ (2-ethylhexyl terephthalate), there are only very low losses by evaporation in the case of the compounds mentioned. The compounds mentioned are also only very poorly soluble in water, whereby these can generally be regenerated simply by stripping with steam. Specifically, the stripping of Hexamoll® DINCH® (di(isononyl) 1,2-cyclohexanedicarboxylate) with steam should not be problematic since Hexamoll® DINCH® (di(isononyl) 1,2-cyclohexanedicarboxylate) is already stripped with steam in the manufacturing process. Hexamoll® DINCH® (di(isononyl) 1,2-cyclohexanedicarboxylate) is generally thermally stable to 250° C.

Hexamoll® DINCH® (di(isononyl) 1,2-cyclohexanedicarboxylate), Plastomoll® DOA (di(2-ethylhexyl) adipate) and Eastman 168™ (2-ethylhexyl terephthalate) were investigated for their suitability as absorption medium for depleting aromatic hydrocarbons from a crude gas stream and compared to Agnique® ME 18 RD-F.

A gas stream laden with aromatic hydrocarbon is known as crude gas, whereas the gas stream obtained after absorption in the respective absorbent is referred to as pure gas. The carrier gas used was nitrogen at a flow volume of 100 L/h in the standard state.

To obtain the crude gas loading, a wash bottle was filled with 250 g of liquid BTX mixture. The BTX mixture used is a colorless to yellow liquid having a density of 830 kg/m³ at 15° C. (DIN 51757) and is poorly soluble in water. The boiling point is 195° C. (Guideline 92/69/EWG, A.2).

The BTX mixture generally comprises 1-15% by weight benzene, 5-25% by weight toluene, 7-16% by weight xylene, 8-17% by weight styrene, 0-2% by weight propylbenzene, 1.5-3.5% by weight cyclopentene, 0-0.5% by weight 1,2,3,4-tetrahydronaphthalene, 1-10% by weight naphthalene, 3-7% by weight ethylbenzene, 1-5% by weight 2-methylstyrene and 0-0.5% by weight biphenyl, wherein the sum total of the percentages is at most 100.

For all experiments, the wash bottle for saturating the gas stream with aromatic hydrocarbon was filled with 250 g of fresh BTX mixture from the same reservoir. The nitrogen stream (carrier gas) was finely distributed in the liquid via a sintered glass frit in order to ensure a large mass transfer area. The experimental temperature was set to 23° C. The experimental duration was 60 min in each case. The composition of the crude gas stream can be taken from Table 3.

The nitrogen stream laden with aromatic hydrocarbon (crude gas stream) was subsequently passed into an absorption apparatus filled with 200 g of absorption medium. A perforated dis-persal device was used and an immersion depth thereof of 160 mm was set. The liquid level was about 210 mm in total. The absorption medium was also stirred during the respective ex-periment. The gas stream depleted of aromatic hydrocarbon (pure gas) after flowing through the absorption medium was passed through two wash bottles connected in series and each filled with about 150 g of N,N-dimethylacetamide. The pressure at the outlet of the last wash bottle corresponded to ambient pressure. A slight elevated pressure of 5 to 10 mbar can be present in the absorption apparatus. The aromatic hydrocarbons dissolved in N,N-dimethylacetamide were determined by means of headspace GC. This gave the residual loading of the pure gas stream.

The loading of the crude gas stream was determined analogously, in which the absorption apparatus was not filled with absorption medium. From the difference of the aromatic hydrocarbon absorbed in the N,N-dimethylacetamide from the crude gas and of the aromatic hydrocarbon absorbed in the N,N-dimethylacetamide after flowing through the respective absorption medium, the absorption performance of the individual absorption media was determined. An absorption medium is then generally more suitable for absorbing aromatic hydrocarbon if the difference is high.

The composition of the crude gas stream and the compositions of the respective pure gas streams after absorption in the respective absorbent are presented in Table 3.

TABLE 3

| | | Pure gas stream | | | | |
|---|---|---|---|---|---|---|
| | | (after absorption in the respective absorbent) | | | | |
| | Crude gas stream | Hexamoll ® | Plastomoll ® | EASTMAN | Agnique | |
| | (laden nitrogen) | DINCH ® | DOA | 168 ™ | ME 18 RD-F | WINOG 70 |
| | mg/Nm³ | mg/Nm³ | mg/Nm³ | mg/Nm³ | mg/Nm³ | mg/Nm³ |
| Benzene | 8390 | 2686 | 3001 | 3642 | 3138 | 3895 |
| Toluene | 17105 | 1886 | 1899 | 2441 | 1973 | 2816 |
| o-Xylene | 1042 | 34 | 30 | 38 | 45 | 51 |
| m-Xylene | 2753 | 102 | 100 | 128 | 102 | 168 |
| p-Xylene | 1346 | 61 | 63 | 69 | 64 | 81 |
| Ethylbenzene | 3578 | 155 | 136 | 208 | 155 | 229 |
| Styrene | 4107 | 116 | 100 | 132 | 102 | 185 |
| Indane | 194 | 5 | 17 | 6 | 17 | 8 |
| Indene | 319 | 11 | 17 | 6 | 17 | 8 |

The depletion of the aromatic hydrocarbons from the crude gas stream is shown in Bar graph 1.

Table 3 and Bar graph 1 show that benzene and indane in particular can be depeleted from the crude gas stream by Hexamoll®DINCH®, Plastomoll® DOA and EASTMAN 168™.

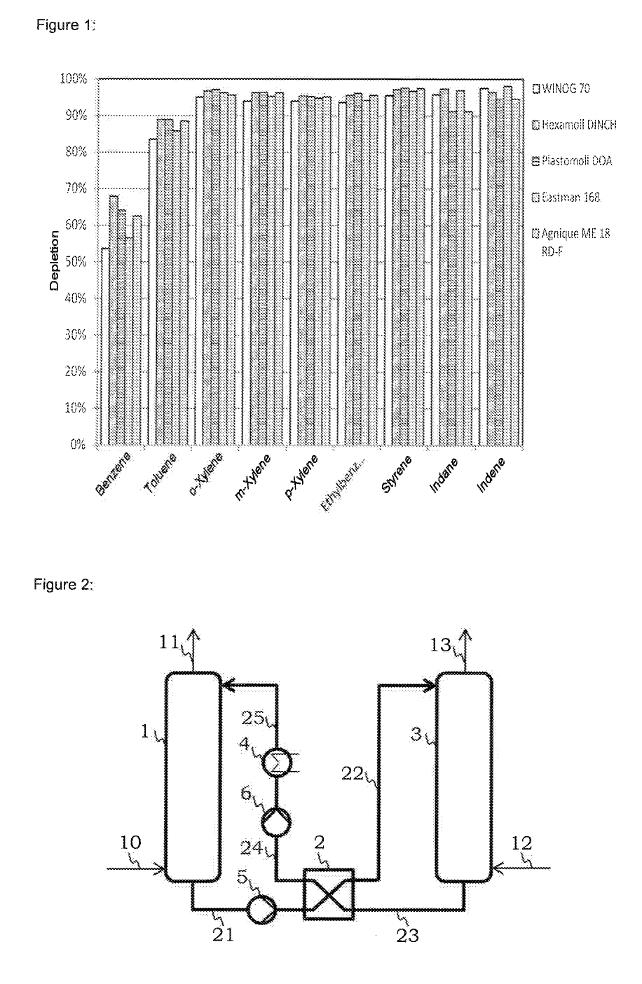

### Working Example (FIG. 1)

The crude gas stream 10 is brought into contact in countercurrent with the absorption medium (25) in a scrubber (1). The scrubber is operated at approximately atmospheric pressure and a temperature of 50° C. The aromatic hydrocarbon present in the crude gas stream is depleted from the gas phase and transfers into the absorption medium. The pure gas stream (11) exits the scrubber via the overhead. The absorption medium (21) laden with aromatic hydrocarbon exits the scrubber and is heated in an internal heat exchanger (2). The laden absorption medium (22) thus heated is brought into contact in countercurrent flow with steam (12) as stripping medium in a regeneration device (3). The aromatic hydrocarbon present in the absorption medium is depleted therefrom and transfers into the stripping medium. The stripping medium laden with aromatic hydrocarbon exits the regeneration device via the overhead (13). The regenerated absorption medium (23) is cooled in a heat exchanger against the laden absorption medium. The cooled and regenerated absorption medium (24) is brought to the desired operating temperature in a cooler (4) and recycled to the scrubber (1).

In order to overcome pressure drops on the liquid side, pressure boosting machines (5,6) for example are incorporated in the absorption medium streams. The pressure drop on the gas side can be overcome, for example, by blowers before or after the scrubber. Hexamoll®DINCH®, Plastomoll® DOA or EASTMAN 168™ are used as absorption medium (25).

1-16. (canceled)

17. A method for depleting aromatic hydrocarbon from a crude gas stream, comprising the use of an absorption medium one or more compounds of the general formula (I): 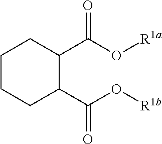
wherein R^{1a} and R^{1b} are each independently C₇ to C₁₂-alkyl.

18. The method according to claim 17, wherein the absorption medium comprises di(isononyl) 1,2-cyclohexanedicarboxylate.

19. The method according to claim 17, wherein a further absorption medium is used which is different from the absorption medium disclosed in claim 17.

20. The method according to claim 18, wherein a further absorption medium is used which is different from the absorption medium disclosed in claim 18.

21. The method according to claim 19 wherein further comprises an additional absorption medium different to the absorption medium and is used for depleting inorganic compounds from the crude gas stream.

22. The method according to claim 19, wherein the absorption medium different to the absorption medium which comprises di(isononyl) 1,2-cyclohexanedicarboxylate and is used for depleting inorganic compounds from the crude gas stream.

23. The method according to claim 19, wherein the absorption medium different to the absorption medium which comprises di(isononyl) 1,2-cyclohexanedicarboxylate and is used in a further method operation.

24. The method according to claim 17, wherein the absorption medium and crude gas stream are fed past each other in co-current or countercurrent flow.

25. The method according to claim 23, wherein the absorption medium and crude gas stream are fed past each other in co-current or countercurrent flow.

26. An absorption medium, wherein the absorption medium comprises di(isononyl) 1,2-cyclohexanedicarboxylate.
